(19) United States
(12) Patent Application Publication
(10) Pub. No.: US 2025/0346738 A1
(43) Pub. Date: Nov. 13, 2025

(54) HIGH TEMPERATURE CONDUCTIVE ELASTOMERS AND METHODS THEREOF

(71) Applicant: The Boeing Company, Arlington, VA (US)

(72) Inventors: Laura Elizabeth WHALEN, Saint Charles, MO (US); Jerry Lee NEWLAND, Warrenton, MO (US)

(73) Assignee: The Boeing Company, Arlington, VA (US)

(21) Appl. No.: 18/657,886

(22) Filed: May 8, 2024

(51) Int. Cl. C08K 9/04; C08L 83/04; C09D 7/62; C09D 183/04

(52) U.S. Cl. CPC C08K 9/04; C08L 83/04; C09D 7/62; C09D 183/04; C08K 2201/001; C08L 2203/16

(57) ABSTRACT

An electrically conductive composition is disclosed, including a polydimethylsiloxane-based resin, an electrically conductive filler, coated with an additive, and where the electrically conductive filler is coated with a treatment that may include a metal, and where the additive may include an organometallic compound including titanium. In examples, the electrically conductive composition can include carbon nanotubes, nickel graphite, functionalized carbon nanotubes, tungsten carbide, functionalized fullerene, graphene, nickel powder or a combination thereof. A coated article and a method for coating the article are also disclosed.

### TECHNICAL FIELD

The present teachings relate generally to high temperature elastomer formulations and, more particularly, to formulations and methods of making high temperature conductive elastomers.

### BACKGROUND

In the area of aerospace and aviation, the use of advanced materials capable of meeting rigorous performance standards is of continuing interest. High conductivity elastomers find many uses in these fields, such as static discharging, conductive ground planes or maintaining conductivity during service use.

While high temperature conductive elastomers are known, supply chain assurance and material availability can be of concern, and therefore may prompt the development of new materials or formulations that meet the requirements for use in aerospace. For example, known high temperature conductive elastomers based on fluoroelastomer resins meet service requirements, but are no longer being manufactured.

Therefore, it is desirable to design and formulate high conductive elastomers that meet or exceed performance and service requirements of existing formulations.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

An electrically conductive composition is disclosed. The electrically conductive composition includes a polydimethylsiloxane-based resin. The composition also includes an electrically conductive filler, coated with an additive, and where the electrically conductive filler is coated with a treatment which may include a metal, and the additive may include an organometallic compound including titanium. Implementations of the electrically conductive composition can include where the electrically conductive filler may include carbon nanotubes, nickel graphite, functionalized carbon nanotubes, tungsten carbide, functionalized fullerene, graphene, nickel powder or a combination thereof. The metal may include nickel. The additive may include [2,2-bis [(2-propenyloxy)methyl]-1-butanolato-o,o′,o″]tris(neodecanoato-o) titanium. The additive can be present in an amount of from about 0.25 wt % to about 5 wt % based on an amount of the electrically conductive filler. The electrically conductive filler is present in an amount of from about 10 to about 25 volume percent based on a total volume of the electrically conductive composition. The electrically conductive composition may include one or more solvents. The one or more solvents may include a low molecular weight silicone, a ketone, or a combination thereof. The one or more solvents may include a low molecular weight silicone and methylisobutyl ketone in a ratio of from about 1:3 to about 3:1 by volume. A viscosity of the electrically conductive composition is from about 5 Pa-s to about 100 Pa-s.

A coated article is disclosed. The coated article includes a polymeric material having at least one surface, and an electrically conductive coating layer on the at least one surface, and where the electrically conductive coating layer may include a polydimethylsiloxane-based resin, and an electrically conductive filler, where the electrically conductive filler is coated with an additive, the additive may include a metal and an organometallic compound. Implementations of the coated article can include where the metal is selected from Al, Ag, Au, Co, Cr, Cu, Fe, Ni, Mo, Pd, Pt, Rb, Rh, Ru, Sn, Ti W, Zn, Zr, steel, or alloys thereof. The polymeric material may include epoxy, phenolics, polyesters, ureas, melamines, polyamides, polyimides, poly-ether-ether-ketones (PEEK), poly-ether-ketone-ketones (PEKK), polyphthalamides, polyphtalates, polysulfones, polyurethanes, chlorinated polymers, fluorinated polymers, polytetrafluoroethylene, polycarbonates, liquid crystal polymers, partially crystalline aromatic polyesters, and modified versions thereof containing one or more fillers or reinforcement materials may include carbon, carbon nanotubes, graphite, carbon fibers, graphite fibers, fiberglass, glass fibers, metals, metal alloys, metalized fibers and metal coated glass fibers. The polymeric material is a component or part of an aerospace vehicle. The component or part of an aerospace vehicle is an external surface thereof.

A method for applying an electrically conductive composition to an article is disclosed. The method includes immersing an electrically conductive filler in a solution which can include a metal to create a dispersion. The method also includes heating the dispersion to form a metal coated electrically conductive filler. The method also includes treating the metal coated electrically conductive filler with an organometallic composition. The method also includes mixing a polydimethylsiloxane-based resin in a planetary mixer. The method also includes adding the metal coated electrically conductive filler to the polydimethylsiloxane-based resin. The method also includes adding a solvent to the planetary mixer. Implementations of the method for applying an electrically conductive composition to an article may include applying the electrically conductive composition to a substrate. The method for applying an electrically conductive composition to an article may include applying the electrically conductive composition to the substrate by spraying. The substrate is a carbon fiber composite substrate. The electrically conductive filler may include carbon fiber, the metal may include nickel, the organometallic composition may include a titanate, and the solvent may include a low molecular weight polydimethylsiloxane and a ketone.

The features, functions, and advantages that have been discussed can be achieved independently in various implementations or can be combined in yet other implementations, further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIGS. 1A and 1B are scanning electron microscope photographs of formulations without and with additives, respectively, in accordance with the present disclosure.

FIG. 2 is a plot depicting resistivity vs. time of several high temperature conductive elastomer formulations, in accordance with the present disclosure.

FIG. 3A illustrates a schematic view of a vehicle, and an application of a structural component including an electrically conductive composition applied to an aerospace vehicle, in accordance with the present disclosure.

FIG. 3B is an exploded view of a structural component including an electrically conductive composition applied to an aerospace vehicle, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

The present disclosure provides a polydimethylsiloxane-based resin, also referred to as a silicone elastomer that is formulated with a metal coated carbon fiber filler and a neoalkoxy titanate additive. The material can be fabricated using either a planetary style mixer or high-speed dispersion with the filler being slowly added to the mixing vessel and diluted with one or more solvents, including a low viscosity polydimethylsiloxane. In examples, a low molecular weight silicone or polydimethylsiloxane, such as DOWSIL™ OS-2 or methylisobutyl ketone (MIBK) can be used as solvents. The resulting mixed or formulated material can then be spray applied or otherwise coated onto a composite substrate at a variable thickness, depending on the desired resistivity value of the resulting article. The conductive elastomeric material can be cured for up to seven days at room temperature (approximately 25° C.) or exposed to an elevated temperature, for example, for 1 hour at 450° F.

The electrically conductive elastomer material formulation of the present can create a stable and consistent conductivity and resistivity over time for use in electronic service applications where low thicknesses are desired, such as in printed circuit boards or other electrical components. The addition of neoalkoxy titanate impacts the properties of the resin by improving the interfacial interactions between an added conductive filler and the silicone resin, which aids in electron flow and results in more stable conductivity and resistivity over time as compared to materials without this additive or particular formulation.

The polydimethylsiloxane-based resin, for example, DOWSIL™ 3145, is primarily composed of a polydimethylsiloxane (PDMS), at approximately 83% PDMS by volume, or from about 75% to about 85% volume percent of the PDMS resin in examples. This and other PDMS materials possess a low dielectric constant and dissipation factor, high thermal stability, and good chemical resistance. Other commercially available polydimethylsiloxane-based resins that could be used as alternatives include Dow SYLGARD™ 184 Silicone Elastomer, Sartomer® R9603, or RTV-615, RTV-630 from Momentive™.

In examples, a nickel coated carbon fiber filler used in the formulation is a conductive material that exhibits improved corrosion resistance and electrical conductivity compared to uncoated carbon fibers. The process for nickel coating the carbon fibers involves immersing the carbon fibers in a nickel sulfamate solution and then heating the mixture to form a nickel coating on the surface of the fibers. Other conductive fillers that could be used as alternatives include carbon nanotubes, nickel graphite, functionalized carbon nanotubes, tungsten carbide, functionalized fullerene, graphene, or nickel powder, indium tin oxide, or combinations thereof. Nickel coated carbon fibers can alternatively be produced using a chemical vapor deposition process to deposit nickel by thermal decomposition of a nickel bearing gas. Alternately, cementation, electroless and electroplating techniques can be used to coat the carbon fibers with nickel. These processes can also be used with alternate metals or conductive fillers as described herein. In other examples, metals such, but not limited to Al, Ag, Au, Co, Cr, Cu, Fe, Ni, Mo, Pd, Pt. Rb, Rh, Ru, Sn, Ti, W, Zn, Zr, steel, combinations and alloys thereof could be used to coat the carbon fiber or other conductive fillers. In examples, metal coated filler is coated with a layer of metal having a thickness between 0.5 and 2 micrometers.

### Additives

Additional additives that are useful in the present formulation include silane coupling agents, or organometallic compounds. These can include compositions of reactive organometallic species based on aluminum, titanium, zirconium or combinations thereof and compositions including reactive silane coupling agents dispersed in organic solvents. Illustrative examples can include neoalkoxy titanate additives, such as organo-titanate LICA 01, which acts as an interfacial agent between the PDMS resin and conductive filler to improve wetting and adhesion. It further serves to improve thermal stability and electrical conductivity compared to untreated resins with similar filler content. Other additives that could be used to improve interfacial interactions between the conductive filler and resin include monoalkoxy titanate additives, zirconate additives, silane treatments, or a mixture thereof.

The one or more reactive silanes, also referred to as silane adhesion promoters or silane coupling agents, of the present disclosure can be capable of or configured to facilitate improved formulation properties. The one or more additives can be or include, but are not limited to, one or more compounds including at least one reactive silane, or organometallics including reactive titanate, reactive zirconate, reactive aluminates, or the like, or any combination thereof. Organosilanes are generally understood to be, but not necessarily limited to, multifunctional silicon-containing molecules that include a reactive functional group and one or more hydrolysable alkoxy group. Illustrative silanes can include, but are not limited to, bis(trimethoxysilylethyl)benzene, bis(triethoxysilylethyl)benzene, 3-Acryloxypropyltrimethoxysilane, 3-Methacryloxypropyltrimethoxysilane, aminopropyltrimethoxysilane, vinyl trimethoxysilane, allyl trimethoxysilane, or combinations thereof. Illustrative glycidoxy functional or epoxy functional silanes may include, but are not limited to, glycidoxypropyltrialkoxysilane (such as glycidoxypropyltrimethoxysilanes, 3-glycidoxypropyltrimethoxysilane, 3-glycidoxypropyltriethoxysilane, and the like), 3-(2,3-epoxypropoxypropyl)methyldiethoxysilane, 2-(3,4-epoxycyclohexyl)ethyltrimethoxysilane, 3-(2,3-epoxypropoxypropyl)methyldimethoxysilane, 2-(3,4-epoxycyclohexyl)ethylmethyldimethoxysilane, 8-glycidoxyoctyltrimethoxysilane, 1-(3-glycidoxypropyl)-1,1,3,3,3-pentaethoxy-1,3-disilapropane, and combinations thereof. Illustrative mercapto functional silanes may include, but are not limited to, 3-mercaptopropyltriethoxysilane, 3-mercaptopropyltrimethoxysilane, 11-mercaptoundecyltrimethoxysilane, s-(octanoyl) mercaptopropyltriethoxysilane, (mercaptomethyl)methyldiethoxysilane, 3-mercaptopropylmethyldimethoxysilane, mercaptopropyltrialkoxysilanes (such as mercaptopropyltrimethoxysilanes 3-Mercaptopropyltrimethoxysilane), mercaptoundecyltrimethoxysilane, (mercaptomethyl)methyldiethoxysilane, and combinations thereof.

Organometallics included as additives in the conductive high temperature elastomer composition may include reactive titanate, reactive zirconate, reactive aluminates, or the like, or any combination thereof. Organometallic compounds are generally understood to be any member of a class of compounds containing at least one metal-to-carbon bond in which the carbon is part of an organic group. Organometallic compounds of the present disclosure may further include metal centers including metals such as, but not limited to, zirconium (Zr), manganese (Mn), lithium (Li), magnesium (Mg), aluminum (Al), zinc (Zn), and iron (Fe). The metal centers may have, but are not limited to, from four to six organic ligands or reactive groups in the organometallic composition. The organometallics may have, but are not limited to, reactive groups or organic ligands including amines, vinyl groups, allyl ether groups, acrylic groups, or combinations thereof. The organometallics may have, but are not limited to, non-reactive groups including alkyl, alkoxy, fluoro, phosphates, or combinations thereof. The reactive titanates can, but are not required to, include at least one UV curable functional group, such as an acrylate functional group. The UV curable functional group allows the titanate adhesion promoter to cure or facilitate curing via exposure to UV. The titanate adhesion promoter can include an ethylenically unsaturated titanate containing compound, a neoalkoxy titanate containing compound, or combinations thereof. Illustrative titanate adhesion promoters can include, but are not limited to, tetra(2, 2 diallyoxymethyl)butyl, di(ditridecyl) phosphito titanate, commercially available as KR 55, from Kenrich Petrochemcials, Inc. (hereinafter “Kenrich”) of Bayonne, NJ; neopentyl(diallyl)oxy, trineodecanonyl titanatem, commercially available as LICA 01 from Kenrich; neopentyl(diallyl)oxy, tri (dodecyl)benzene-sulfony titanate, commercially available as LICA 09 from Kenrich; neopentyl(diallyl)oxy, tri (dioctyl)phosphato titanate, commercially available as LICA 12 from Kenrich; neopentyl(dially) oxy, tri (dioctyl) pyro-phosphato titanate, commercially available as LICA38 from Kenrich; neopentyl(diallyl)oxy, tri (N-ethylenediamino)ethyl titanate, commercially available as LICA 44 from Kenrich; neopentyl(diallyl)oxy, tri (m-amino)phenyl titanate, commercially available as LICA 97 from Kenrich; neopentyl(diallyl)oxy, trihydroxy caproyl titanate, commercially available as LICA 99 from Kenrich; or the like, or combinations thereof. It should be noted that any of the previously noted examples including titanate organometallics could alternatively include other metals listed above as substitutions for titanium in the noted compounds.

As used herein, the term “surface” means a surface located on a particular side of an article. A side of an article may include various surfaces or surface areas, including, but not limited to, a polymer article surface area or joint surface area, etc. Thus, when reciting a coating or layer is applied to a “surface” of a polymer or an article made therefrom, it is intended that such surface can comprise any one or all of the surfaces or surface areas located on that particular side of the polymer being coated.

### Polymer Material or Substrate

Examples of polymer materials or polymeric materials that can be used (e.g., as a substrate) that undergoes surface coatings with an electrically conductive elastomeric coating or layer in accordance with the present disclosure include polymer materials that act as a matrix in combination with one or more types of fibers. In one example, materials useful for the practice of the present disclosure include fiber-reinforced plastics (FRP) comprising a polymer material in combination with an inorganic fibers such as fibers of carbon, carbon nanotubes, graphite, fiberglass, glass, metals, metal alloys, or metalized fibers and metal coated glass fibers, alumina fiber or boron fiber. In one example, the fiber reinforced plastic can comprise organic fiber such as a nylon fiber, or aramid fiber. In one example, the fiber reinforced plastic can comprise organic fiber and/or inorganic fiber blended into a thermosetting or epoxy.

In one example, a carbon fiber reinforced plastic (CFRP), carbon fiber composite substrate, or glass fiber reinforced plastic (GFRP) as the polymer article made therefrom is imparted with lightning resistance and/or electromagnetic interference protection and/or electrochemical interaction protection suitable for aircraft structures or the like. However, the present disclosure is not restricted to these types of materials, and articles formed from other polymers can also be used in the presently disclosed process of the present disclosure.

In one example, the polymer substrate comprises a crystalline polymer. Crystalline polymers provide high temperature resistance as well as chemical resistance to FRPs. In another example of the polymer substrate comprises a semi-crystalline polymer. Semi-crystalline polymers provide the benefits of crystalline polymers along with ductility and processing advantages to FRPs. In yet another example, the polymer substrate comprises an amorphous polymer. Amorphous polymers provide resiliency, ductility and processing advantages to FRPs.

In one example the polymer substrate is selected from epoxies, phenolics, polyesters, polyesters, ureas, melamines, polyamides, polyimides, poly-ether-ether-ketones (PEEK), poly-ether-ketone-ketone (PEKK), polyetherimide (PEI), polyphthalamide, polyphtalates, polysulfone, polyurethanes, chlorinated polymers, fluorinated polymers, polytetrafluoroethylene, polycarbonates, liquid crystal polymers, partially crystalline aromatic polyesters, and modified versions thereof containing one or more fillers or reinforcement materials selected from carbon, carbon nanotubes, graphite, carbon fibers, graphite fibers, fiberglass, glass fibers, metals, metal alloys, metalized fibers and metal coated glass fibers. In examples, the composite substrate can include one or more metals or a ceramic material. The substrates can form a base for a coated article including an electrically conductive composition. In other examples, electrically conductive elastomers of the present disclosure can include titanium or steel or other high temperature metallic materials or alloys capable of operation within a temperature range of from about 400° F. to about 500° F. Examples can be or include, but are not limited to, steels, aluminum, titanium, metallic alloys, as well as cadmium plated, zinc plated, or zinc-nickel plated metals or alloys as described herein.

### Electrically Conductive Coatings

Polydimethylsiloxane-based resins are primarily composed of polydimethylsiloxane (PDMS) with compositions having up to 83% by volume, or from about 75% to about 85% volume percent of the PDMS resin in examples. The addition of nickel coated carbon fiber fillers of a nominal level of 17 volume percent based on a total volume of the formulation can improve the electrical conductivity and corrosion resistance compared to unfilled resins. In examples, ranges of from about 5 to about 30 volume percent, or from about 17 to about 25 volume percent, or from about 17 to about 20 volume percent of metal coated carbon fiber fillers can be used. Metal coatings, for example, nickel, onto conductive filler particles or fibers involves immersing carbon fibers in a nickel sulfamate solution (for nickel) and then heating them to form the metal coating on the surface of the fibers or other filler material. This process results in improved adhesion between the filler and resin, enhancing the overall performance of the conductive material.

The use of organometallic additives, such as LICA 1, which is a neoalkoxy titanate from Kenrich as an additive at a nominal amount of 2 wt % of total filler amount can serve to enhance interfacial interactions between the conductive filler and the resin, aiding in electron flow and resulting in more stable conductivity or resistivity over time compared to materials without this additive. In examples, a range of organometallic additive can be from about 0.25 wt % to about 5 wt % based on the weight of total filler

During fabrication and mixing of the electrically conductive compositions, the high-speed dispersion process enables the final properties of the conductive material by increasing the surface area and homogeneity of the filler within the resin, resulting in improved conductivity and stability over time compared to materials without this treatment. Other solvents that could be used as alternatives include dimethylcyclohexane (DCH), dimethyl polysiloxane (PDMS), or hexamethyldisiloxane (HMDS), DOWSIL™ OS-20 as well as other organic solvents mentioned herein.

The one or more organic solvents can be or include, but are not limited to, aliphatic hydrocarbons, aromatic compounds, such as aromatic hydrocarbons, halogenated hydrocarbons, nitrated hydrocarbons, ketones, amines, esters, alcohols, aldehydes, ethers, or the like, or combinations thereof.

Illustrative aliphatic hydrocarbon that can be utilized as the one or more organic solvents can be or include, but are not limited to, n-pentane, n-hexane, n-octane, n-nonane, n-decane, or homologues thereof, 2,2,4-trimethyl pentane, or the like, or any combination thereof.

Illustrative aromatic compounds that can be utilized as the one or more organic solvents can be or include, but are not limited to, cyclohexane, benzene, toluene, ethylebenzene, xylene, tetralin, hexafluoro xylene, or the like, or any combination thereof.

Illustrative halogenated hydrocarbons that can be utilized as the one or more organic solvents can be or include, but are not limited to, chloroform, methylene chloride, trichloro ethylene, dichloromethane, or the like, or combinations thereof.

Illustrative ketone organic solvents can be or include, but are not limited to, acetone, methyl ethyl ketone (MEK), diethyl ketone, methyl propyl ketone (MPK), dipropyl ketone, methyl isobutyl ketone (MIBK), cyclopentanone, cyclohexanone, methyl amyl ketone, n-methyl-2-pyrrolidone, diisobutyl ketone, acetophenone, or the like, or combinations thereof.

Illustrative esters that can be utilized as the one or more organic solvents can be or include, but are not limited to, methyl acetate, ethyl acetate, isopropyl acetate, n-butyl acetate, cellosolve acetate, or the like, or combinations thereof.

Illustrative alcohols that can be utilized as the one or more organic solvents can be or include, but are not limited to, methanol, ethanol, n-propanol, i-propanol, n-butanol, i-butanol, s-butanol, n-amyl alcohol, i-amyl alcohol, cyclohexanol, n-octanol, ethanediol, diethylene glycol, 1,2-propanediol, or the like, or combinations thereof.

Illustrative aldehydes that can be utilized as the one or more organic solvents can be or include, but are not limited to, furfuraldehyde, or the like.

Illustrative ethers that can be utilized as the one or more organic solvents can be or include, but are not limited to, diethyl ether, diisopropyl ether, dibutyl ether, methyl tert butyl ether, 1,4-dioxane, tetrahydrofuran, oligomers of perfluoropolyethers, such as the GALDEN® line, which is commercially available from Solvay of Houston, TX, or the like, or combinations thereof.

Certain embodiments of electrically conductive compositions as described herein may have very different viscosities which may be tailored according to their method of application. The amount of the one or more organic solvents present in the electrically conductive compositions can vary widely, which may directly influence the viscosity of an electrically conductive composition. The low viscosity solvent compositions can be applied to a surface or between two substrates by way of brushing, airbrush spraying, spray gun, dropping, pouring, pipetting, wiping, and the like. The amount of the one or more organic solvents present can be at least partially determined by a target or desired viscosity of the electrically conductive composition. The amount of the one or more organic solvents present in the electrically conductive composition can be from about 75 weight % to about 99.5 weight %, based on a total weight of the electrically conductive composition. For example, the amount of the one or more organic solvents present in an electrically conductive composition can be from about 75 weight %, about 80 weight %, about 85 weight % or about 90 weight % to about 95 weight %, about 98 weight %, about 99 weight %, or about 99.5 weight %, based on a total weight of the electrically conductive composition. In another example, the amount of the one or more organic solvents present in the electrically conductive composition may be from about 75 weight % to about 99.5 weight %, about 80 weight % to about 99 weight %, about 85 weight % to about 95 weight %, or about 85 weight % to about 90 weight %, based on a total weight of the electrically conductive composition.

The coating compositions described herein can have a shear viscosity of from about 0.01 Pa·s to about 10 Pa·s, at a temperature of about 25° C. For example, the coating composition can have a shear viscosity of from about 0.01 Pa·s, about 2 Pa·s, about 4 Pa·s, or about 5 Pa·s to about 6 Pa·s, about 8 Pa·s, about 9 Pa·s, or about 10 Pa·s at a temperature of about 25° C. In another example, the coating composition can have a shear viscosity of from about 0.01 Pa·s to about 10 Pa·s, about 2 Pa·s to about 8 Pas, or about 4 Pas to about 6 Pa·s, at a temperature of about 25° C. The measurement of the coating composition may be conducted at a shear rate of about 0.1 Hz to about 100 Hz, at a temperature of about 25° C. The coating composition can have a viscosity of about 0.01 to about 10 Pas at a shear rate of about 0.1 to about 100 sec⁻¹.

The application method used for this material can be conducted using a gravity feed or HVLP spray gun, which is recommended for achieving consistent coating thicknesses. Other application methods that could be used as alternatives include electrostatic spraying or roll coating. The specific parameters for the spray application method, such as spray pressure and distance from substrate, can usefully affect the thickness and uniformity of the applied material.

In examples, the method of applying the electrically conductive composition to a composite substrate results in approximately 12-18 mils thickness, (from about 300 microns to about 500 microns) depending on the desired resistivity value. In examples, achieving consistent coating thicknesses includes adjusting the spray distance and pressure according to the specific substrate being coated and monitoring the coating thickness during application. In some examples, a resulting thickness of coating application can be from about 100 microns to about 1 mm, or from about 300 microns to about 750 microns.

In examples, the curing process for this conductive material involves ambient curing for up to seven days at room temperature and normal humidity conditions, which is typically sufficient for most silicone formulations. Room temperature is considered to be from about 15° C. to about 30° C., with normal humidity conditions from about 50% to 80% relative humidity. The curing process can impact the final properties of the conductive material by cross-linking the resin and forming a stable, non-porous layer around the conductive filler, which helps maintain its conductivity over time. Other elevated temperature curing methods that could be used as alternatives include curing at temperatures from about 350° F. to about 450° F. or post-curing at higher temperatures, for example, at about 500° F. In other examples, it may be useful to adjust the curing conditions or utilize curing methods, such as UV curing or heat curing at higher temperatures.

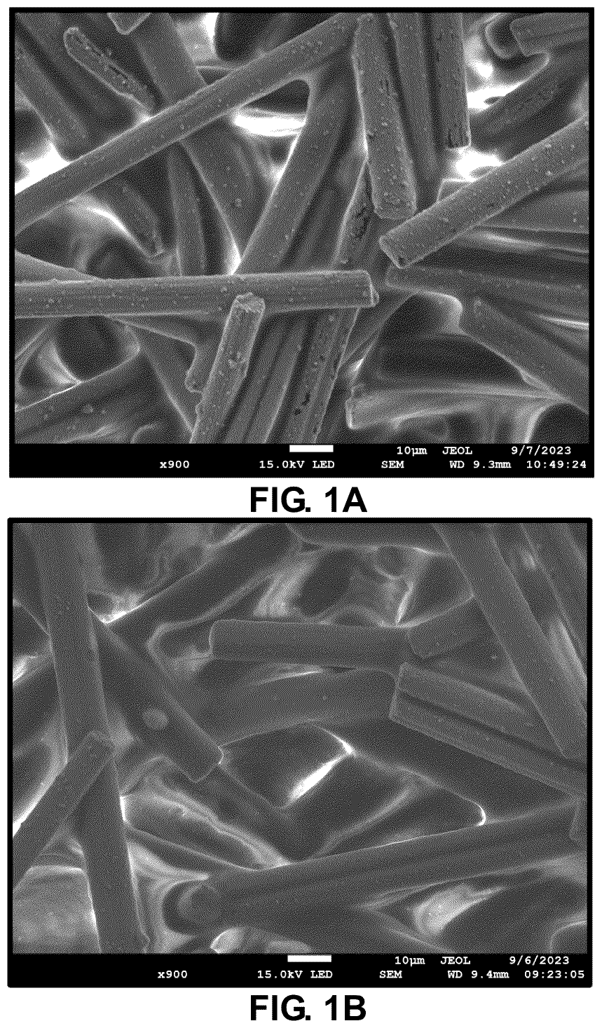

FIGS. 1A and 1B are scanning electron microscope photographs of formulations without and with additives, respectively, in accordance with the present disclosure. As described herein, the formulation of fillers having additives, as shown in FIG. 1B, as loaded into a commercial off the shelf (COTs) PDMS decreases resistivity below a target threshold at ambient as desired. The decrease in resistivity values below the target threshold can be attributed to the improved interfacial interactions between the resin and filler material due to introduction of the aforementioned additive as demonstrated by the scanning electron microscope images.

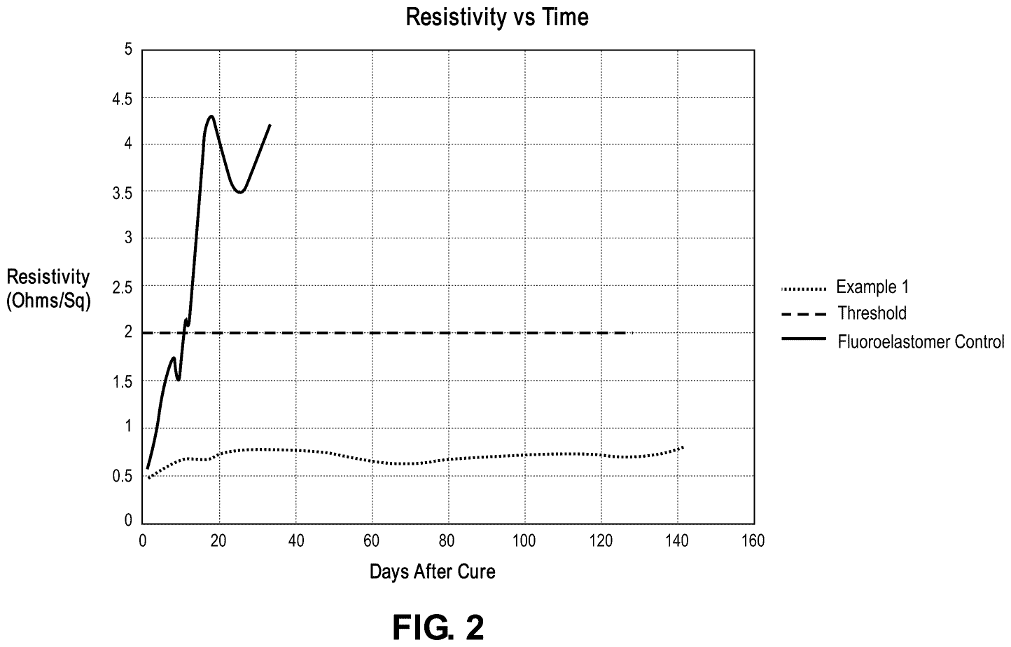

FIG. 2 is a plot depicting resistivity vs. time of several high temperature conductive elastomer formulations, in accordance with the present disclosure. The resistivity of high temperature elastomeric materials have a propensity to increase over time. This can be caused by thermal exposure and resulting degradation of the material during this exposure. The resistivity of an exemplary formulation described herein. Example 1, is shown in comparison to a threshold target value and a previous formulation, labeled as Fluoroelastomer Control. The fluoroelastomer control sample shows an instable increase in resistivity over time, as compared to the Example 1 formulation of the present disclosure, which demonstrates the stability of the formulation over time. The conductivity is assessed over time by measuring resistivity with a Loresta 4-point probe to ensure the resistivity value does not creep, or change, over time. In examples, a suitable range of resistivity for compositions of the present disclosure can be from about 0.25 ohms/sq to about 1.5 ohms/sq, or from about 0.5 ohms/sq to about 1.0 ohms/sq, or from about 0.5 ohms/sq to about 0.75 ohms/sq.

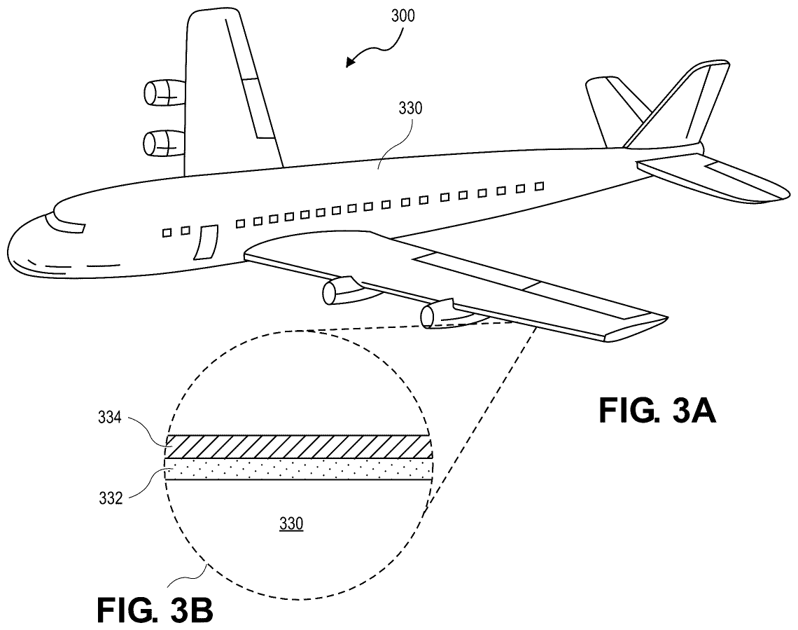

FIG. 3A illustrates a schematic view of a vehicle, and an application of a structural component including an electrically conductive composition applied to an aerospace vehicle, in accordance with the present disclosure. An application of the presently disclosed coating composition or method is shown on an aerospace vehicle 300, whereby vehicle substrate 330 is applied with the presently disclosed coating composition. Exploded view 3B is shown having vehicle substrate surface 330 with substrate surface layer 332 and electrically conductive composition layer 334 so as to impart electrical conductivity to the surface of the substrate 330, and/or into a structural component of or a portion of a vehicle. In one example the application of the presently disclosed coating composition is directed to an external surface of the aerospace vehicle 300. In examples, additional coating layers, such as paints, coatings, or other protective coatings can be applied upon the electrically conductive composition layer 334. It should be noted that substrate surface layer 332 is optional in certain examples. Examples of the present disclosure can be fabricated using centrifugal, acoustic or high speed dispersion mixing methods. Additionally, examples can be fabricated, including cured samples, by casting or spray application using gravity feed, HVLP, air atomized or robotic spray applications known to those skilled in the art.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. An electrically conductive composition, comprising:
a polydimethylsiloxane-based resin; and
an electrically conductive filler, coated with an additive; and wherein:
the electrically conductive filler is coated with a treatment comprising a metal; and
the additive comprises an organometallic compound comprising titanium.

2. The electrically conductive composition of claim 1, wherein the electrically conductive filler comprises carbon nanotubes, nickel graphite, functionalized carbon nanotubes, tungsten carbide, functionalized fullerene, graphene, nickel powder or a combination thereof.

3. The electrically conductive composition of claim 1, wherein the metal comprises nickel.

4. The electrically conductive composition of claim 1, wherein the additive comprises [2,2-Bis [(2-propenyloxy)methyl]-1-butanolato-O,O′,O″]tris(neodecanoato-O) titanium.

5. The electrically conductive composition of claim 1, wherein the additive is present in an amount of from about 0.25 wt % to about 5 wt % based on an amount of the electrically conductive filler.

6. The electrically conductive composition of claim 1, wherein the electrically conductive filler is present in an amount of from about 10 to about 25 volume percent based on a total volume of the electrically conductive composition.

7. The electrically conductive composition of claim 1, further comprising one or more solvents.

8. The electrically conductive composition of claim 7, wherein the one or more solvents comprise a low molecular weight silicone, a ketone, or a combination thereof.

9. The electrically conductive composition of claim 8, wherein the one or more solvents comprise a low molecular weight silicone and methylisobutyl ketone in a ratio of from about 1:3 to about 3:1 by volume.

10. The electrically conductive composition of claim 9, wherein a viscosity of the electrically conductive composition is from about 5 Pa·s to about 100 Pa·s.

11. A coated article, comprising:
a polymeric material having at least one surface; and
an electrically conductive coating layer on the at least one surface; and wherein the electrically conductive coating layer comprises:
a polydimethylsiloxane-based resin; and
an electrically conductive filler, wherein the electrically conductive filler is coated with an additive, the additive comprising a metal and an organometallic compound.

12. The coated article of claim 11, wherein the metal is selected from the group consisting of Al, Ag, Au, Co, Cr, Cu, Fe, Ni, Mo, Pd, Pt, Rb, Rh, Ru, Sn, Ti W, Zn, Zr, steel, or alloys thereof.

13. The coated article of claim 11, wherein the polymeric material comprises epoxy, phenolics, polyesters, ureas, melamines, polyamides, polyimides, poly-ether-ether-ketones (PEEK), poly-ether-ketone-ketones (PEKK), polyphthalamides, polyphtalates, polysulfones, polyurethanes, chlorinated polymers, fluorinated polymers, polytetrafluoroethylene, polycarbonates, liquid crystal polymers, partially crystalline aromatic polyesters, and modified versions thereof containing one or more fillers or reinforcement materials comprising carbon, carbon nanotubes, graphite, carbon fibers, graphite fibers, fiberglass, glass fibers, metals, metal alloys, metalized fibers and metal coated glass fibers.

14. The coated article of claim 11, wherein the polymeric material is a component or part of an aerospace vehicle.

15. The coated article of claim 14, wherein the component or part of an aerospace vehicle is an external surface thereof.

16. A method for applying an electrically conductive composition to an article, comprising:
immersing an electrically conductive filler in a solution comprising a metal to create a dispersion;
heating the dispersion to form a metal coated electrically conductive filler;
treating the metal coated electrically conductive filler with an organometallic composition;
mixing a polydimethylsiloxane-based resin in a planetary mixer;
adding the metal coated electrically conductive filler to the polydimethylsiloxane-based resin; and
adding a solvent to the planetary mixer.

17. The method for applying an electrically conductive composition to an article of claim 16, further comprising applying the electrically conductive composition to a substrate.

18. The method for applying an electrically conductive composition to an article of claim 17, further comprising applying the electrically conductive composition to the substrate by spraying.

19. The method for applying an electrically conductive composition to an article of claim 17, wherein the substrate is a carbon fiber composite substrate.

20. The method for applying an electrically conductive composition to an article of claim 16, wherein:
the electrically conductive filler comprises carbon fiber;
the metal comprises nickel;
the organometallic composition comprises a titanate; and
the solvent comprises a low molecular weight polydimethylsiloxane and a ketone.
